(19) United States
(12) Patent Application Publication
(10) Pub. No.: US 2002/0149479 A1
(43) Pub. Date: Oct. 17, 2002

(54) METHOD AND DEVICE FOR ELECTRONICALLY PROTECTING ITEMS AGAINST THEFT

(76) Inventors: DETLEF DUSCHEK, SENSBACHTAL (DE); ULRICH SILBERZAHN, IGELSBACH (DE)

Correspondence Address: FELIX J D'AMBROSIO, JONES TULLAR & COOPER, PO BOX 2266, EADS STATION, ARLINGTON, VA, 22202

(21) Appl. No.: 09/331,162

(22) PCT Filed: Dec. 11, 1997
(86) PCT No.: PCT/EP97/06929

(30) Foreign Application Priority Data
Dec. 21, 1996 (DE) 196539315

(51) Int. Cl. G08B 13/14

(52) U.S. Cl. 340/572.1; 340/571; 340/568.1

(57) ABSTRACT

The invention relates to a method and device for electronically protecting items against theft. Said device consists of a security element which is integrated into the item and is excited within a given security area by an interrogation field of a transmitting device to generate a characteristic signal, wherein a receiver device triggers an alarm upon recognition of the characteristic signal. The invention has the aim of providing a method and a device enabling protection of the supply of items made from varying materials. This is done by providing a shape-retaining security element and/or a shape-retaining security element enclosed by shape-retaining casing, and by embedding or integrating said device in the item during manufacturing.

The invention relates to a device and a method for electronically protecting items against theft, comprising a security element which is integrated into the item and within a security zone is excited by the interrogation field of a transmitting device to transmit a characteristic signal, and a receiving device, on detecting the characteristic signal, trips an alarm. The security element itself may be located either on or directly below the surface of the item but is inseparably joined to it.

Integrally protected items, that is, items in which the security element used for electronically protecting them is already integrated into the item in the production of the item, have already become known from German Patent Disclosure DE 38 32 289 A1. This published, non-examined patent application in particular describes integrating a security element of little thickness into an item made of paper. The security element is positioned between two opposed layers of paper pulp, from which a sheet of paper is then made by a conventional process.

The object of the invention is to propose a device and a method which make integral protection of items made from the most various materials possible.

With regard to the device, this object is attained in that the security element is shape-retaining and/or surrounded by a shape-retaining casing, and that the security element which is shape-retaining and/or surrounded by a shape-retaining casing is embedded or integrated into the item during the production process for the item. Particularly if the security elements are strip elements, they are made from very thin, lamination-like metal strips, which if not given suitable support can be further processed only with difficulty because of their flexibility. Within the scope of the invention, shape-retaining accordingly means not that the security elements must have a rigid shape but that they must be inflexible enough to be manipulatable without problems.

In an advantageous refinement of the device of the invention, the security element—as already noted—is an active or deactivatable strip element, which is surrounded by a shape-retaining casing of plastic; the item or at least parts of the item furthermore comprise plastic; the production is done by the injection molding process; the plastic of the casing is selected such that during the injection molding of the item or part of the item, it melts, and the security element enters into an intimate connection with the finished item or the part of the finished item. This part may for instance be the plastic housing of an electrical device, such as a drilling machine.

Alternatively, it is provided that the security element is an active or deactivatable strip element, which is surrounded by a shape-retaining casing of plastic; and the security element is embedded and sealed in an opening originally present in the item.

In accordance with an advantageous feature of the device of the invention, it is also proposed that the security element is embedded and sealed in an opening separately made in the item. For instance, this opening is drilled into the item.

An advantageous refinement of the device of the invention provides that the shape-retaining security element is a CD ring, made of thin-film material, which ring is positioned, during the injection molding of the CD, around the middle opening thereof. Such CD rings are already known from the prior art; they are glued from outside onto the cd around the center opening. However, this known method is problematic in the sense that these glued-on rings come loose from the CD when the CD is being played and can possibly damage the CD player.

A further advantageous embodiment of the device of the invention proposes that the security element is a resonant frequency security element or a magnetoacoustic security element, and the adhesives joining the individual parts of the security element to one another have a melting temperature that is above the temperature required for the injection molding of the plastic. This characteristic is absolutely necessary in the sense that the adhesive layer in resonant frequency security elements can under some circumstances take on the function of the dielectric layer disposed between the conductor tracks or printed circuit boards. If the dielectric layer melts, then naturally the security element is not longer functional.

Furthermore, resonant frequency security elements are described at length in European Patent Disclosure EP 0 665 702 A1; magnetoacoustic security elements have become known from EP 0 096 182 B1.

With regard to one embodiment of the method of the invention, it is provided that the security element is provided in the extrusion process with a plastic casing, and that the security element, during the injection molding of the item or of a part of the item, is embedded or integrated inseparably into the item. Extrusion processes for sheathing purposes are routine, for instance in the field of electric cable production. The adoption of this method according to the invention to the field of electronically protecting items is associated here with a considerable cost reduction in the production of the encased security elements.

An advantageous feature of the method of the invention provides that the security element is placed in an injection mold; that the material of the casing is selected such that it melts during the injection molding; and that the security element, after the plastic has set, is inseparably joined to the item.

An alternative version proposes that the security element is placed in an injection mold; that the material of the casing is selected such that its melting temperature is higher than the temperature that occurs during the injection molding; and that the encased security element is embedded in the item.

An especially favorable feature it is proposed that the extruded security element is in the form of bandware and is placed in the injection mold via an actuating device; and that the band length required for one security element is cut from the band before or in the process of the closure of the injection mold.

It is understood that it is also possible that the security element is in the form of an individual part and is placed in the injection mold by an actuating device.

With respect to the special embodiment, already mentioned, of the security element as a CD ring, the stated object is attained in that a CD ring is furnished in the form of thin-film material; that the CD ring is placed in an injection mold and inside the injection mold is positioned in such a way that it is integrated with the CD around the center opening of the CD.

The object of the invention is also attained by the following method steps: the security element is provided in the extrusion process with a plastic casing, and the security element is introduced, during the assembly process of an applicator used in the cosmetic field, into the shaft of the applicator. The integral protection is attained here by providing that during the usual assembly steps needed to produce an item, the security element is embedded in a fitting part of the item.

A further method of the invention that attains the stated object proposes that the security element is provided in the extrusion process with a plastic casing; a bore is made in the item; the security element is placed in the bore; and the bore is sealed off from the outside. Once again, the security element has thus become an inseparable part of the item; the item is integrally protected.

The invention will be described in further detail in conjunction with the ensuing drawings. Shown are:

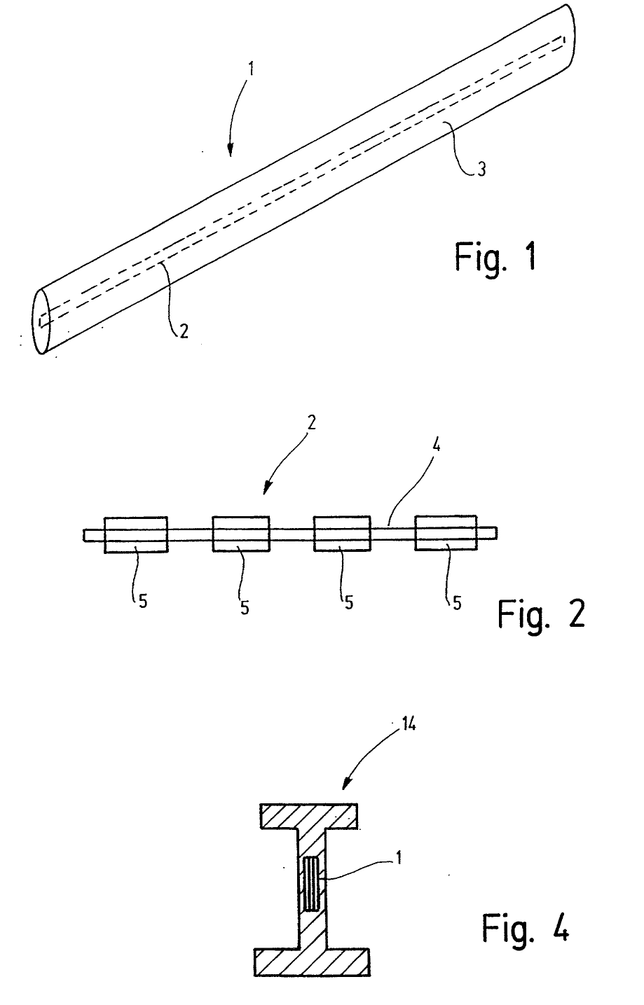

FIG. 1, a perspective view of a security element of the invention;

FIG. 2, a plan view on a deactivatable strip element;

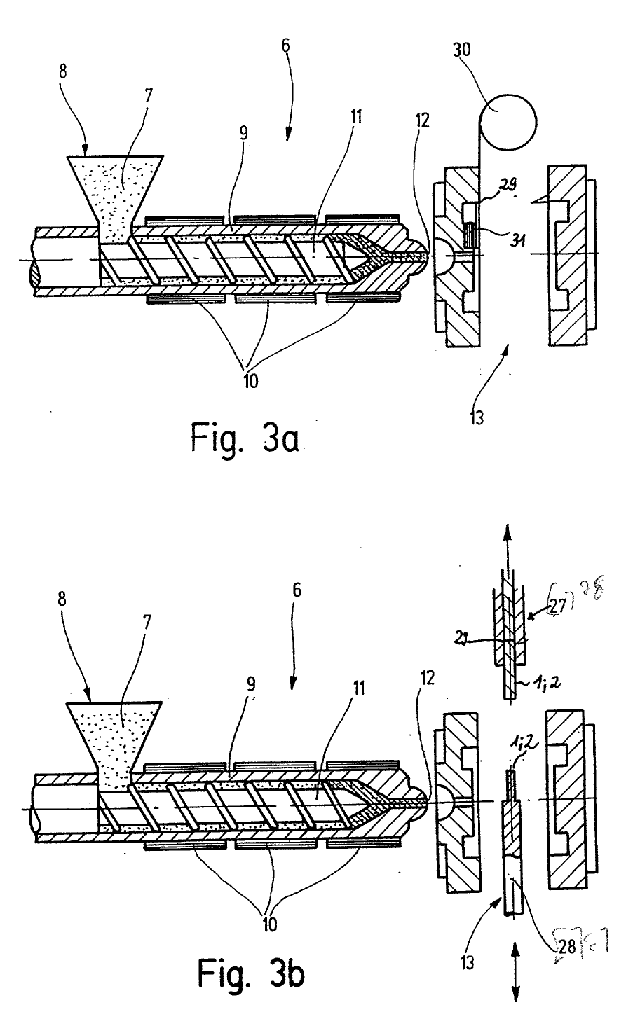

FIG. 3a: a longitudinal section through a first embodiment of an injection molding device for performing the method of the invention;

FIG. 3b: a longitudinal section through a second embodiment of an injection molding device for performing the method of the invention;

FIG. 4: a cross section through a first integrally protected item;

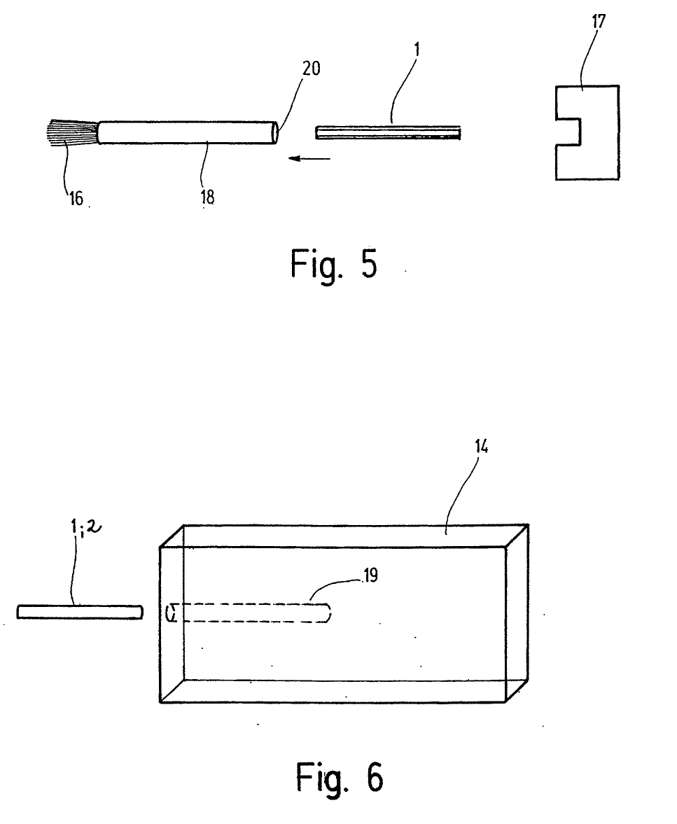

FIG. 5: a cross section through a second integrally protected item;

FIG. 6: a cross section through a third integrally protected item;

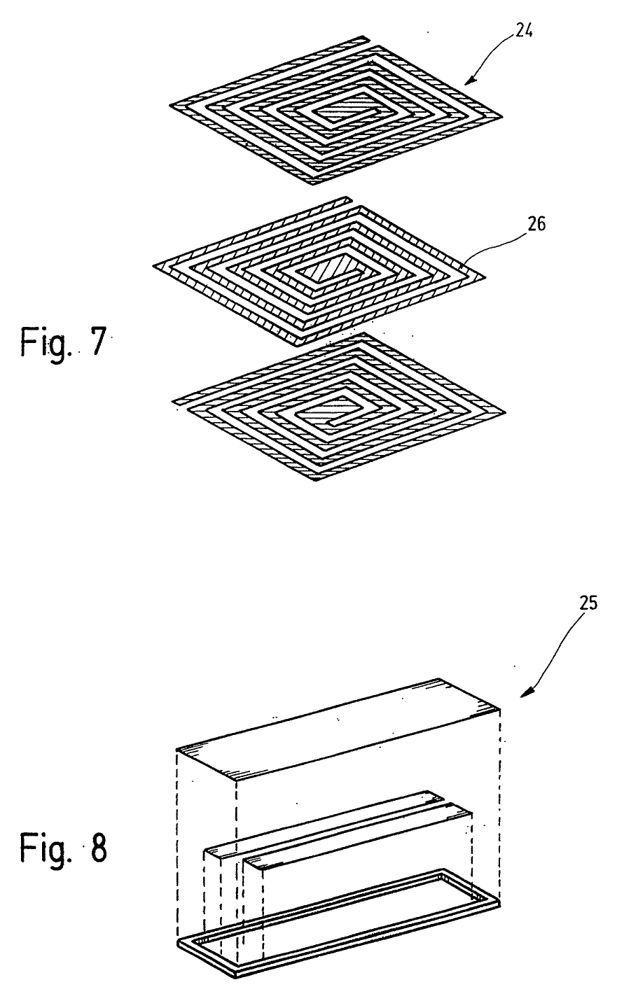

FIG. 7: an exploded view of a resonant frequency security element;

FIG. 8: an exploded view of a magnetoacoustic security element; and

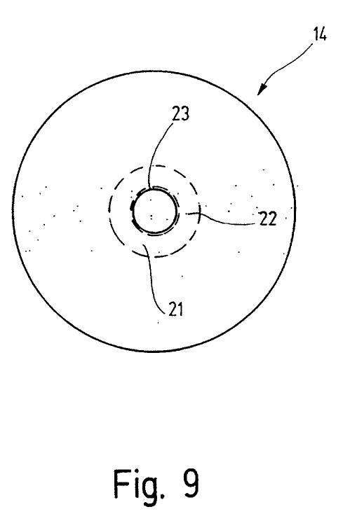

FIG. 9: a plan view on a CD (compact disc) secured by means of a CD ring.

FIG. 1 shows a perspective view of a security element 1 according to the invention. The security element 1 is a strip element 2, which to improve its stability is provided with a casing 3. The casing 3 is preferably plastic, which is applied around the strip element 2 in the extrusion process and subsequently encases it entirely. By means of the casing 3, shape retention of the security element 2 is attained that allows it to be integrated without problems into further processing processes.

FIG. 2 shows a plan view on a deactivatable strip element 2. The strip element 2 comprises a strip of soft magnetic material 4, on which segments of semihard magnetic or hard magnetic material 5 are disposed. The production materials for the strip elements 2 are relatively expensive. They are therefore made as thin and narrow as absolutely possible. Consequently, in terms of their consistency they can be compared with laminations. Such materials with little shape retentions are difficult to process further; this is true for their inclusion in either automated or manual production processes. This disadvantage can be effectively eliminated by the casing 3.

FIGS. 3a and 3b show longitudinal sections through embodiments of an injection molding device 6 for performing the method of the invention. Both embodiments are excellently suited to dividing up strip elements 2, present in the form of band materials, into individual strip elements 2 and integrating them into the items 14.

The basic design of both injection molding devices 6 is the same. An injection molding device 6 comprises a cylinder 9, which is supplied via a funnel 7 with raw material 8. The raw material 8 is melted in the cylinder 9 via heating plates 10, moved via the worm 11 in the direction of the outlet nozzle 12, and placed in the injection mold 13 as soon as the injection mold is closed. The device shown in FIG. 3a functions in detail as follows: From the storage roll 30, the desired length of one security element 1 (strip element 2) is unwound. Since the security element 1 is magnetic, it is held in the desired position inside the injection mold 13 by the magnet 29. Upon closure of the injection mold 13, a cutting device 31 is actuated, which severs the strip element 2 in the end region of the injection mold 13. If the security elements 1 are not strip elements 1 but arbitrary other elements, then once again they are placed individually by a delivery device 27 into the injection mold 13 and held in the desired position by a magnet.

The delivery device 28 shown in FIG. 3b for the security elements 1—in particular, this device 28 again serves to deliver strip elements 2 present in the form of band material—functions as follows: The delivery device 27 is driven into the opened injection mold 13 and pushes the free end of the band material into the opening of the core puller 28; the core puller 28 firmly holds the strip element 2. A cutting device 31 is integrated with the delivery device 27 and cuts off a portion from the band material that corresponds to the desired length of the strip element 2. The delivery device 27 is then moved out of the injection mold 13, the injection mold 13 is closed, and the flowable raw material 8 is placed in the injection mold 13. After hardening has occurred, the core puller 28 is retracted from the finished item 14. Once again, the strip element 2 is firmly integrated with the item 14 to be secured.

FIG. 4 shows a cross section through a first integrally secured item 14, which has been produced by the injection molding process. In the instance shown, a strip element 2 with casing 3 is integrated into the item.

As already noted, a variant of the method of the invention for producing a device for electronically protecting items proposes that the strip element 2, which has a casing 3, be introduced during the assembly process of the item 14 into a fitting part of the item 14. This variant can be seen in FIG. 5. The opening 20 for receiving the security element 1 here is already originally present in the item 14. What is shown here is in particular an applicator for cosmetic products, such as nail polish. A brush 16 is mounted on one end of the shaft 18, which is hollow on the inside; the strip element 2, carrying a casing 3, is then introduced into the hollow shaft 18; next, the still-open end of the shaft 18 is closed by means of the cap piece 17. The applicator is placed in a nail polish bottle, which is closed by means of the cap piece 17. The cosmetic product is subsequently integrally protected against any kind of improper manipulation.

FIG. 6 shows a cross section through a third integrally secured item 14. A bore 19 is made in the item 14, and the security element 1 is introduced into the bore. The bore 19 is subsequently sealed off from the outside.

In FIGS. 7 and 8, two further features of the security elements 1 can be seen in exploded views. Once again, these can be integrated in the manner described above with the items 14 to be protected. As already described for the case of the strip element 2, both the resonant frequency security element 24 (FIG. 4) and the magnetoacoustic security element 25 (FIG. 8) can be provided with a sheath or casing 3 before they are introduced into the item 14 and joined inseparably to it. It should be noted here that the adhesive 26 used to join the individual parts of the security elements 24, 25 together has a melting temperature which is above the temperatures that occur in the extrusion process or the injection molding process.

n. 9 shows a plan view on a CD (compact disc) 14 secured by means of a CD ring 22. The CD ring 22 is a ring of so-called thin-film material 21. Thin-film material 21 is presented in detail in EP 0 295 028 B1. During the manufacture of the basic body of the cd 14, the cd ring 22 of thin-film material 21 is placed around the center opening 23 of the cd 14—which is preferably again done with the aid of a magnet 29—and embedded into the plastic material. After that, the security element 1 is again inseparably joined to the item 14.

List of Reference Numerals

| | |
|---|---|
| 1 | Security element |
| 2 | Strip element |
| 3 | Casing |
| 4 | Soft magnetic material |
| 5 | Semihard magnetic or hard magnetic material |
| 6 | Injection molding device |
| 7 | Funnel |
| 8 | Raw material |
| 9 | Cylinder |
| 10 | Heating strip |
| 11 | Worm |
| 12 | Outlet nozzle |
| 13 | Injection mold |
| 14 | Item |
| 15 | Applicator |
| 16 | Brush |
| 17 | Closure cap |
| 18 | Shaft |
| 19 | Bore |
| 20 | Opening |
| 21 | Thin-film material |
| 22 | CD ring |
| 23 | Center opening |
| 24 | Resonant frequency security element |
| 25 | Magnetoacoustic security element |
| 26 | Adhesive |
| 27 | Delivery device |
| 28 | Core puller |
| 29 | Cutting device |
| 30 | Storage roll |
| 31 | Magnet |

1. A device for electronically protecting items against theft, comprising a security element which is integrated into the item and within a security zone is excited by the interrogation field of a transmitting device to transmit a characteristic signal, and a receiving device, on detecting the characteristic signal, trips an alarm
characterized in that
the security element (1) is shape-retaining and/or surrounded by a shape-retaining casing (3), and that the security element (1) which is shape-retaining and/or surrounded by a shape-retaining casing (3) is embedded or integrated into the item (14) during the production process for the item.

2. The device of claim 1,
characterized in that
the security element (1) is an active or deactivatable strip element (2), which is surrounded by a shape-retaining casing (3) of plastic;
the item (14), or at least parts of it, are of plastic made by the injection molding process; and
the plastic of the casing (3) is selected such that during the injection molding of the item (14) or part of the item (14), it melts, and the security element (1) enters into an intimate connection with the finished item (14) or the part of the finished item (14).

3. The device of claim 1 or 2,
characterized in that
the security element (1) is an active or deactivatable strip element (2), which is surrounded by a shape-retaining casing (3) of plastic; and
the security element (1) is embedded and sealed in an opening (20) originally present in the item.

4. The device of claim 1,
characterized in that
the security element (1) is embedded and sealed in an opening (19) separately made in the item.

5. The device of claim 1,
characterized in that
the shape-retaining security element (1) is a CD ring (22), made of thin-film material (21), which ring is positioned, during the injection molding of the CD (14), around the middle opening (23) thereof.

6. The device of claim 1,
characterized in that
the security element (1) is a resonant frequency security element (24) or a magnetoacoustic security element (25), and the adhesives (26) joining the individual parts of the security element (1) to one another have a melting temperature that is above the temperature required for the injection molding of the plastic.

7. A method for electronically protecting items against theft, comprising a security element which is integrated into the item and within a security zone is excited by the interrogation field of a transmitting device to transmit a characteristic signal, and a receiving device, on detecting the characteristic signal, trips an alarm,
characterized in that
the security element (1) is provided in the extrusion process with a plastic casing (3), and that the security element (1), during the injection molding of the item (14) or of a part of the item (14), is embedded or integrated inseparably into the item (14).

8. The method of claim 7,
characterized in that
the security element (1) is placed in an injection mold; that the material of the casing (3) is selected such that it melts during the injection molding; and
that the security element (1), after the plastic has set, is inseparably joined to the item (14).

9. The method of claim 7,
characterized in that
the security element (1) is placed in an injection mold; that the material of the casing (3) is selected such that its melting temperature is higher than the temperature that occurs during the injection molding; and
that the encased security element (1) is embedded in the item (14).

10. The method of claim 8 or 9,
characterized in that
the extruded security element (1) is in the form of bandware and is placed in the injection mold (13) via an actuating device 27; 28; and
that the band length required for one security element (1) is cut from the band before or in the process of the closure of the injection mold (13).

11. A method of claim 8 or 9,
characterized in that
the security element (1) is in the form of an individual part and is placed in the injection mold (13) by an actuating device (27).

11. A method for electronically protecting items against theft, comprising a security element which is integrated into the item and within a security zone is excited by the interrogation field of a transmitting device to transmit a characteristic signal, and a receiving device, on detecting the characteristic signal, trips an alarm,
characterized in that
a CD ring (22) is furnished in the form of thin-film material (21);
that the CD ring (22) is placed in an injection mold (13) and inside the injection mold (13) is positioned in such a way that integration is done in the CD around the center opening (23) of the CD.

12. A method for electronically protecting items against theft, comprising a security element which is integrated into the item and within a security zone is excited by the interrogation field of a transmitting device to transmit a characteristic signal, and a receiving device, on detecting the characteristic signal, trips an alarm,
characterized in that
the security element (1) is provided in the extrusion process with a plastic casing (3); and
that the security element (1) is introduced, during the assembly process of an applicator (15) used in the cosmetic field, into the shaft (18) of the applicator (15).

13. A method for electronically protecting items against theft, comprising a security element and wherein the security element is excited within a security zone by the interrogation field of a transmitting device to transmit a characteristic signal, and a receiving device, on detecting the characteristic signal, trips an alarm,
characterized in that
the security element (1) is provided in the extrusion process with a plastic casing (3);
that a bore (19) is made in the item (14);
that the security element (1) is placed in the bore (19); and
that the bore (19) is sealed off from the outside.
